(19) United States
(12) Patent Application Publication
(10) Pub. No.: US 2017/0024758 A1
(43) Pub. Date: Jan. 26, 2017

(54) Incentivizing Advertiser Networks to Submit Multiple Bids

(71) Applicant: Google Inc., (US)

(72) Inventors: Patrick Hummel, Mountain View, CA (US); Sergei Vassilvitskii, Mountain View, CA (US); Randolph Preston McAfee, Mountain View, CA (US)

(73) Assignee: Google Inc., Mountain View, CA (US)

(21) Appl. No.: 13/887,002

(22) Filed: May 3, 2013

(51) Int. Cl. G06Q 30/00

(52) U.S. Cl. CPC G06Q 30/0226

(57) ABSTRACT

This specification describes technologies relating to content presentation. In general, a computer-implemented system and method is disclosed for providing an incentive to a content provider network to submit multiple bids. One or more processors executing code receive from a computing device associated with a first content provider network a first bid and a second bid. A third bid is received from a computing device associated with a second content provider network. The first bid is determined to be a winning bid based on the first bid being higher than the second bid and the third bid. A first calculation is made of a first amount to charge a first content provider associated with the winning bid, wherein the first amount is less than the amount of the first bid. A second calculation is made of a second amount to pay the first content provider network for providing the first bid and the second bid, wherein the second amount is less than the first amount.

### BACKGROUND OF THE INVENTION

The present disclosure relates to content presentation.

This specification generally relates to facilitating connections and communication between users and information sources.

Users of search engines can locate information by entering queries and receiving lists of results identified by the search engines in response to the queries. Search engine results pages may also include content related to or responsive to the queries. A portion of the content included in this situation can be provided by third-party content networks for possible inclusion with the search results. Such content can also be provided by content networks for inclusion in other network-accessible resources such as websites, applications, games and mobile versions of the foregoing.

In many contexts, content providers have bid amounts associated with their content items, and present only highest bid content in response to requests for content, e.g., in response to an auction. It would be an improvement in the art to incentivize networks of content providers to provide additional content other than highest-bid content in response to queries for content.

### SUMMARY OF THE INVENTION

This specification describes technologies relating to content presentation.

In general, a computer-implemented system and method is provided for providing incentive to a content provider network to submit multiple bids. A first bid and a second bid are received from a computing device associated with a first content provider network. A third bid is received from a computing device associated with a second content provider network. A determination is made that the first bid is a winning bid for being higher than the second bid and the third bid. Moreover, a first amount is to charge a first content provider associated with the winning bid, wherein the first amount is less than the amount of the first bid. A charge of the first amount is made to the first content provider, and a second amount is calculated to pay the first content provider network for providing the first bid and the second bid. Moreover, a third amount may be calculated to pay a publisher of content associated with the first bid, and payment is effected of the second amount to the first content provider network and payment of the third amount to the publisher, wherein the payment to the first content provider network is the incentive.

In one embodiment, the content provider network is an advertising network, bids are from advertisers, and the bids are received by one or more processors associated with an advertising network exchange. In another embodiment, the content provider network relates to real estate, and the bids are from realtors and represent listings. In another embodiment, the content provider network relates to gaming, and the bids relate to computer games. In yet another embodiment, the content provider network relates to clothing and the bids relate to clothing manufacturers. Thus, it will be appreciated that for each of these and other contextual arrangements, without limiting the foregoing, all of the features and functionality provided by the present application can be enjoyed and exploited.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a block diagram of an example hardware arrangement associated with a content presentation system.

FIG. 2 is a block diagram of an example display screen identifying ranked bids in accordance with one or more implementations.

FIG. 3 is a flowchart of an example method 300 for providing an incentive to a content provider network to submit multiple bids.

FIG. 4 is a flowchart of example steps associated with calculating an amount to pay content provider network for submitting multiple bids, in accordance with one or more implementations.

FIG. 5 is a flowchart of example steps associated with calculating an amount to pay a content provider network for submitting multiple bids, in accordance with one or more alternative implementations.

FIG. 6 shows an example of a computing device and a mobile computing device that can be used in connection with computer-implemented methods and systems described in the present specification.

Like reference symbols in the various drawings indicate like elements.

### DETAILED DESCRIPTION OF CERTAIN EMBODIMENTS

By way of overview and introduction, it can be advantageous to receive multiple bids from a single advertiser network in an advertising network exchange, which helps advertiser networks, companies, and publishers maximize their respective returns on investment. Advertiser networks may each conduct an auction in which advertisers submit bids in an effort to show their advertisements on sites associated with one or more content publishers. The advertiser networks may belong to an advertising network exchange that includes a plurality of advertiser networks, in which each of the networks submit to the advertising network exchange at least the winning (e.g., highest) bid received by the respective advertiser network's auction. In such context, an advertiser associated with the advertiser network that submitted the highest bid within the network wins the top spot in the exchange. Although the advertiser wins the top spot in the advertising network exchange, the amount paid by that advertiser is, typically, equal to an amount associated with (or equal to) the second-highest bid received by the advertising network exchange.

In a typical arrangement, each of the advertiser networks that conduct advertiser auctions may submit to an advertising network exchange the highest (winning) bid associated with the respective advertiser network. It is possible, however, that a single advertiser network also receives a second-highest bid price within that network's auction, which is higher than any other bid price received in any related auctions that are conducted in the other advertiser networks.

The present application provides one or more incentives to advertiser networks to submit to an advertising network exchange more than one (i.e., first-highest) bid, and include, for example, at least the second-highest bids that are received from advertisers in connection with the advertiser networks' respective auctions. Accordingly, an advertiser network may receive a direct benefit (i.e., a payment) for submitting to the advertising network exchange the exchange's second-highest bid (in addition to the exchange's first-highest bid). In one or more embodiments, any advertiser network that does not submit more than one bid to the advertising network exchange is not penalized or otherwise negatively impacted.

In one or more implementations, one or more incentive(s) may be calculated to include a payment that is equal to a portion of the amount received by the advertising network exchange. For example and in one or more implementations, a single advertiser network that submits to the advertising network exchange the first-highest bid and the second-highest bid among all of the submitting advertiser networks is paid an amount equal to: alpha*(b_(2)−b_(3)). Further, the publisher receives a payment equal to (1-alpha)*b_(2)+alpha*b_(3), where alpha>0 is a positive constant, b_(2) denotes the second-highest bid submitted to the exchange, and b_(3) denotes the third-highest bid submitted to the advertising network exchange. In one or more implementations, the value of alpha is selected such that an incentive is provided to the advertiser network and publishers to obtain greater payment in expectation for their inventory.

In one or more alternative implementations of the present application, a different form of payment calculation is provided in connection with an advertiser network that submits to the advertising network exchange the first-highest bid and the second-highest bid among all of the advertiser networks. In this alternative implementation, the network that submitted the first and second-highest bids to the exchange receives a payment that is in accordance with an arbitrary function of the number of bids and values of the bids submitted by all the advertiser networks. Moreover and in connection with this alternative implementation, the publisher receives a payment that is equal to the second-highest bid minus the payment received by the advertiser network.

In yet another alternative implementation, the alternative payment calculation described above is further modified by making a payment to the advertiser network that supplied the second-highest bid submitted to the advertising network exchange, even in the event the advertiser network that supplied the second-highest bid submitted to the exchange is different from the advertiser network that supplied the highest bid submitted to the exchange.

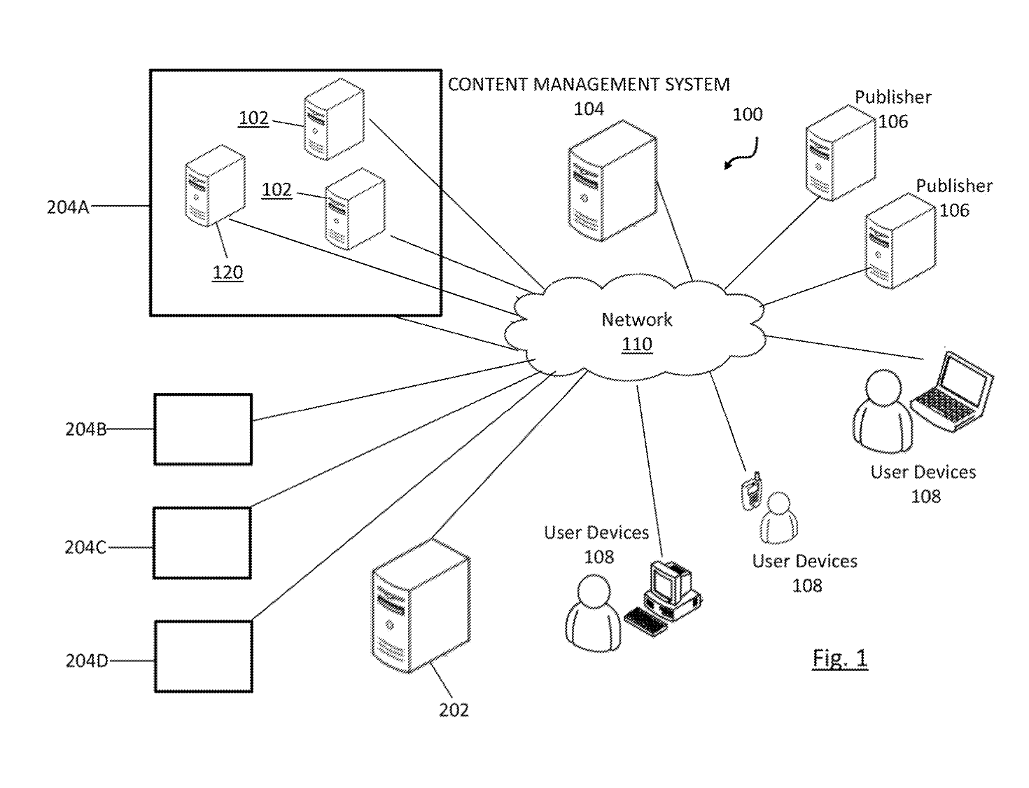

FIG. 1 is a block diagram showing an example content presentation system 100. In some implementations, one or more third party content providers, such as advertisers, using content provider devices 102 can directly or indirectly enter, maintain, and log third party content information such as ad information in a content management system such as system 104. Though reference is made to advertising, other forms of content, including other forms of sponsored content, can be delivered by the system 100. The ads can be in the form of graphical ads, such as banner ads, text-only ads, image ads, audio ads, video ads, media ads, interactive ads, ads combining one or more of any of such components, etc. The ads can also include embedded information, such as links to purchase goods and/or services, meta-information, and/or machine executable instructions.

One or more first party content providers such as publishers, using publisher devices 106 can submit requests for third party content items such as ads to the system 104. The system 104 responds by sending third party content items to the requesting publisher device 106 for placement on, or association with, one or more of the publisher's content items (e.g., web properties such as web pages). It should also be understood that in certain implementations, third party content items such as ads can be provided in a substantially similar manner in television and radio content slots (such as advertising slots), and/or print media space.

Other entities, such as users, using user devices 108, and third party content providers such as the advertisers, using content provider devices 102, can provide usage information to the system 104, such as, for example, whether or not a conversion (e.g., a purchase or other interaction including, for example, a request for driving directions to a location associated with a third party content item such as an ad, navigating to the location associated with a third party content item such as the ad, or walking to the location associated with a third party content item such as the ad) or a click-through related to a third party content item such as an ad (e.g., a user has selected a third party content item such as an ad) has occurred. This usage information can include measured or observed user behavior related to third party content items such as ads that have been served. It should be noted that in situations where personal or identifying information is collected, users may be provided with the ability to control whether such information is collected, the extent to which such information is collected, and/or the extent to which a user can be identified based on it. For example, a user can select an option whereby any personal or identifying information is immediately aggregated with that of other users such that such information cannot subsequently be associated with or otherwise identify the individual user. The system 104 can perform financial transactions, for example, crediting first party content providers such as the publishers 106 and charging third party content providers such as the advertisers 102 based on the usage information.

A network 110, such as a local area network (LAN), wide area network (WAN), the Internet, one or more telephony networks or a combination thereof, connects content provider devices 102, the system 104, publisher devices 106, and user devices 108.

One example publisher device 106 is a general content server that receives requests for first party content (e.g., articles, discussion threads, music, video, graphics, search results, web page listings, information feeds, etc.), and retrieves the requested first party content in response to the request. The content server can submit a request for third party content such as ads to a content server such as an advertisement server in the system 104. The third party content item request can include a number of third party content items such as ads desired. The third party content item request can also include content request information. This information can include the content itself (e.g., page, video broadcast, radio show, or other type of content), a category corresponding to the content or the content request (e.g., arts, business, computers, arts-movies, arts-music, etc.), part or all of the content request, content age, content type (e.g., text, graphics, video, audio, mixed media, etc.), geo-location information, or other suitable information.

In some implementations, the content server or a client browser can combine the requested first party content with one or more of the third party content items such as ads provided by the system 104. The combined first party content and third party content items such as ads can be sent/rendered to the user devices 108 that requested the content for presentation in a viewer (e.g., a browser or other content display system). The content server can transmit information about the third party content items such as ads back to the content server, including information describing how, when, and/or where the third party content items such as ads are to be rendered (e.g., in HTML or JavaScript™).

Another example publisher device 106 is a server that provides a search service. A search service can receive queries for search results. In response, the search service can retrieve relevant search results from an index of documents (e.g., from an index of web pages). Search results can include, for example, lists of web page titles, snippets of text extracted from those web pages, and hypertext links to those web pages, and can be grouped into a predetermined number of (e.g., ten) search results.

The search service can submit a request for third party content items such as ads to the system 104. The request can include a number of third party content items desired. This number can depend on the search results, the amount of screen or page space occupied by the search results, the size and shape of the third party content items, and/or a variety of other factors. In some implementations, the number of desired third party content items will be from one to ten, or from three to five. The request for third party content items can also include the query (as entered or parsed), information based on the query (such as geo-location information, whether the query came from an affiliate and an identifier of such an affiliate), and/or information associated with, or based on, the search results. Such information can include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores can be computed from, for example, dot products of feature vectors corresponding to a query and a document, page rank scores, and/or combinations of IR scores and page rank scores, etc.

In some implementations, the content management system 104 includes an auction process to select third party content items such as ads from the third party content providers such as advertisers. For example, third party content providers such as the advertisers can be permitted to select, or bid, an amount they are willing to pay for each presentation of or interaction with (e.g., click of) a third party content item, e.g., a cost-per-click amount a third party content provider pays when, for example, a user clicks on a third party content item. The cost-per-click can include a maximum cost-per-click, e.g., the maximum amount the third party content provider is willing to pay for each click of a third party content item based on a keyword, e.g., a word or words in a query. Other bid types, however, can also be used. Based on these bids, third party content items can be selected and ranked for presentation.

The search service can combine the search results with one or more of the third party content items provided by the system 104. This combined information can then be forwarded to the user devices 108 that requested the content. The search results can be maintained as distinct from the third party content items, so as not to confuse the user between paid third party content items and presumably neutral search results.

In some implementations, one or more publisher devices 106 can submit requests for third party content items such as ads to a content management system such as content management system 104. The system 104 responds by sending third party content items to the publisher device 106 for placement on one or more of the publisher's web properties (e.g., websites and other network-distributed content) that are relevant to the web property. For example, if a publisher device 106 publishes a sports-related web site, the content management system can provide sports-related ads to the publisher device 106. In some implementations, the requests can instead be executed by devices associated with the user 108, e.g., by the execution of a particular script when the publisher's web page is loading on a client device.

In some alternative implementations, an ad push model is used to provide third party content items such as ads from third party content providers such as advertisers. In an ad push model, ads can be pushed to idle screens (e.g., of a mobile devices or particular applications) based on particular criteria (e.g., the user's location).

In another example the referenced publisher can be a mobile application developer. A mobile application is an application specifically designed for operation on a mobile device (e.g., a smart phone). The mobile application can also include ads positioned within the content of the mobile application. Similar to publishers, the ads can be received from the system 104 for placement in the mobile application when accessed by a user device (e.g., when a particular page of a mobile application is loaded on the mobile device).

For situations in which the systems discussed here collect personal information about users, the users may be provided with an opportunity to control the manner such information is collected with respect to programs or features that may collect personal information (e.g., information about a user's preferences or a user's current location). Users may also be informed of the accompanying limitations on the functionality of a service that may result from limiting access to such personal information. In addition, certain data may be anonymized in one or more ways before it is stored or used, so that personally identifiable information is removed. For example, a device identifier associated with a user's identity may be anonymized so that no personally identifiable information can be determined for the user, or a user's geographic location may be generalized where location information is obtained (such as to a city, zip code, or state level), so that a particular location of a user cannot be determined.

Continuing with reference to FIG. 1, an advertising exchange network for providing third party content to a publisher 106 is shown. In the arrangement 100, a plurality of advertiser networks 204A-D each include a plurality of devices 102. At least one device 120 is included in each advertiser network 204A-D, which receives one or more bids for content such as ads (also known as “creatives”) to be provided on one or more publishers' sites. The bids received by each of the devices 120 are evaluated in an auction and at least two of the bids received from at least one of the respective advertiser networks 204A-D are submitted to device 202 that is associated with advertising network exchange 202. Each content item may include one or more words, phrases, web links, and/or any other such element and/or component (e.g., images, video, audio, etc.) that are provided to one or more publisher devices 106 (e.g., banner ads, text-only ads, image ads, audio ads, video ads, etc.). In certain implementations, one or more keywords (not shown) are associated with one or more creatives in order to enable the identification and selection of pertinent content items for display to a user based on one or more search queries received from the user. It should also be noted that although content items are described herein as referring to individual content items, in certain implementations content items can refer to groups of content items, such as ad groups, campaigns, and/or categories. Device 202 evaluates the bids received from advertiser networks and the bids are, accordingly, ranked in an auction-style format.

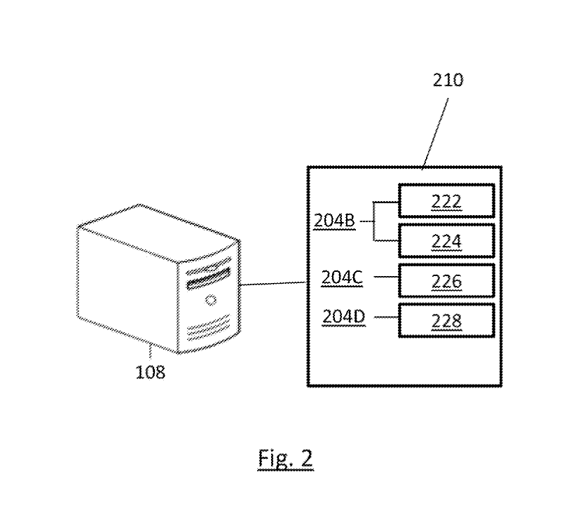

Referring now to FIG. 2, an example ranking of the bids is illustrated on example display 210 that is provided with computing device 108. As shown in display 210, five bids 222, 224, 226 and 228 have been received by device 202 and ranked in an auction-style format. In accordance with the example shown in FIG. 2, the two top bids 222 and 224 were received from network 204B, the third highest bid 226 was received from network 204C, the fourth highest bid was received from network 204D, and the fifth highest bid was received from network 204A. Thus, as shown in the example display 210 in FIG. 2, the two highest bids were received from a single network (204B).

It should be noted that in situations where personal or identifying information is collected, users may be provided with the ability to control whether such information is collected, the extent to which such information is collected, and/or the extent to which a user can be identified based on it. For example, a user can select an option whereby any personal or identifying information is immediately aggregated with that of other users such that such information cannot subsequently be associated with or otherwise identify the individual user.

Additionally, device 202 may include a content selection engine. The content selection engine can select one or more third party content items, such as content items, such as based on various determinations computed with respect to probability. It should also be understood that in some implementations the content selection engine may include one or more processors configured by code to implement the functionality of the content selection engine that is being described.

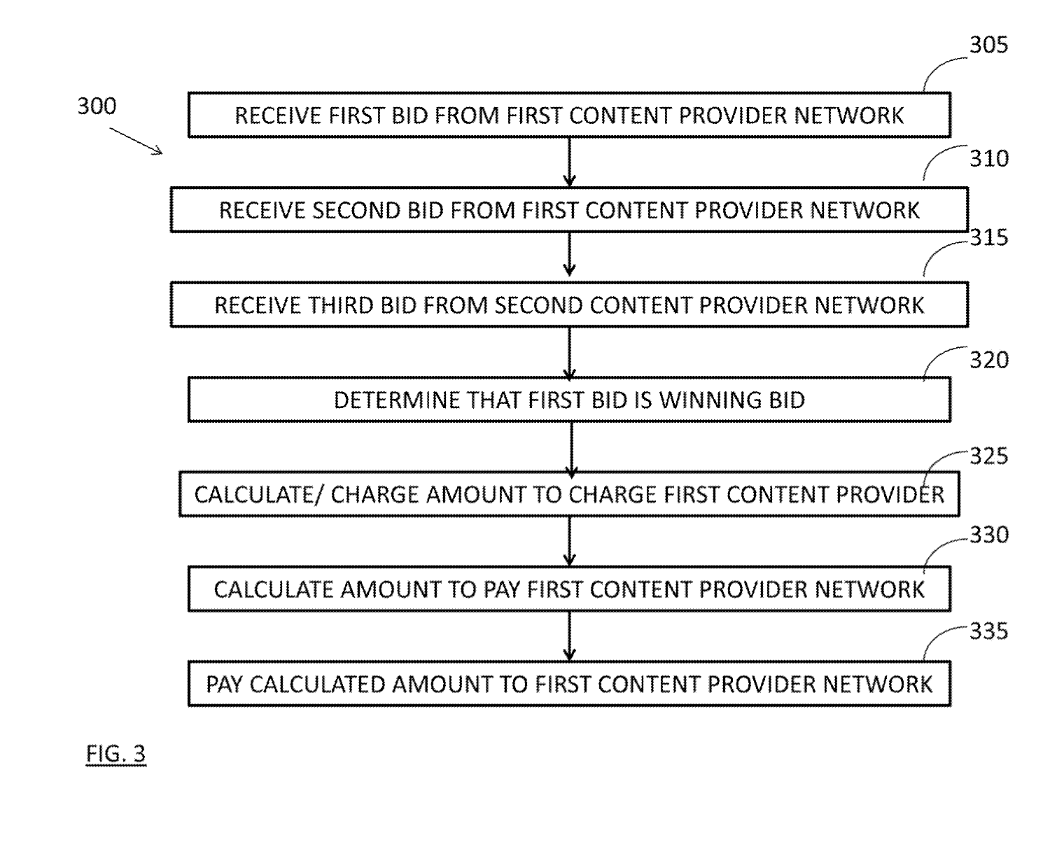

FIG. 3 is a flowchart of an example method 300 for providing an incentive to an advertiser network to submit multiple bids, in accordance with one or more implementations. In some implementations, the method 300 can be performed by a processor executing instructions in a computer-readable storage medium. For example, the method 300 can be performed by the device 202 of FIG. 2.

In certain implementations, a first bid is received from a first of a plurality of advertiser networks, for ranked placement among a list of advertisers (305). The bid price may represent a price for favorable placement within the list in order to attract consumers. In addition, a second bid is received from the first of the plurality of advertiser networks (310). The second bid is different from the first bid. Moreover, a third bid is received from a second of the plurality of advertiser networks (315).

Continuing with reference to FIG. 3, a determination is made that the first bid is a winning bid among the three received bids, for being higher than the second bid and the third bid (320). In accordance with at least one implementation, a calculation is made of a first amount to charge a first advertiser associated with the first bid (325). In one or more implementations, the amount that is charged is less than the amount of the first bid, and the charge is effected. In addition, a calculation is made of an amount to pay the first advertiser network for submitting the first and second bids (330).

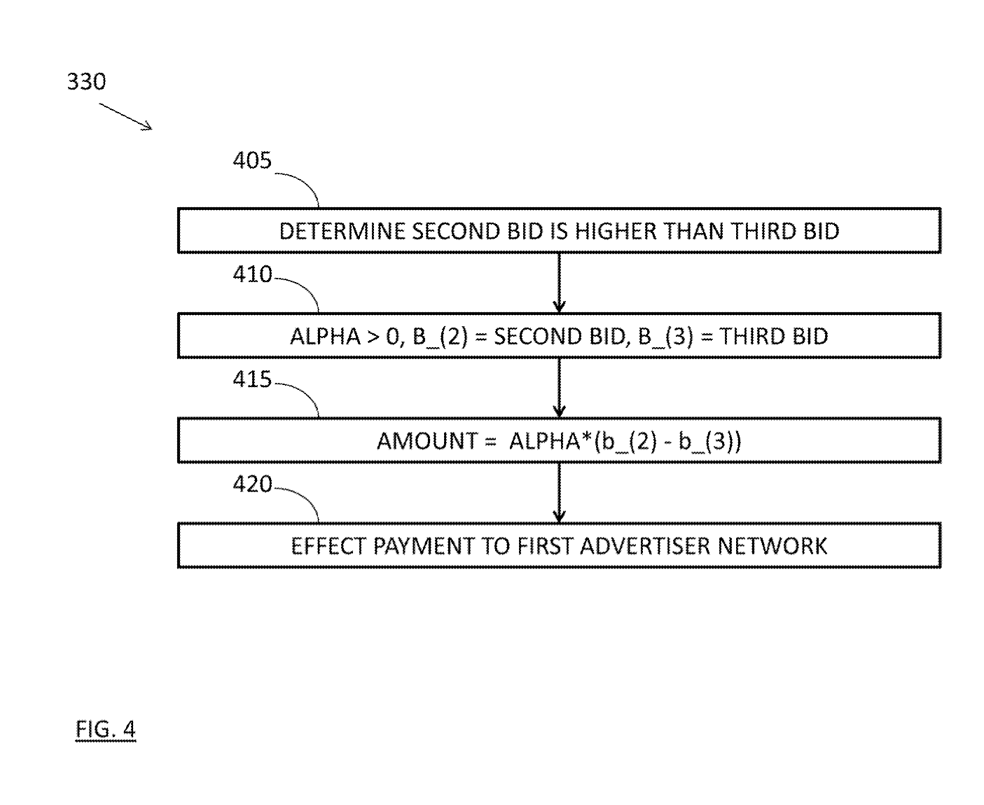

FIG. 4 is a flowchart of example steps associated with calculating an amount to pay the first advertiser network for submitting the first and second bids in accordance with one or more implementations (330). At step 405, a determination is made that the second bid, which was received from the first advertiser network, is higher than the third bid. Thus, the first advertiser network provided the first-highest bid and the second-highest bid of all bids received by the advertising network exchange. At step 410, alpha is set to be greater than 0, and b_(2) is defined to be the amount of the second bid and b_(3) is defined to be the amount of the third bid. At step 415, the amount is calculated to be alpha*(b_(2)−b_(3)). Thereafter, at step 420, payment is effected to the first advertiser network.

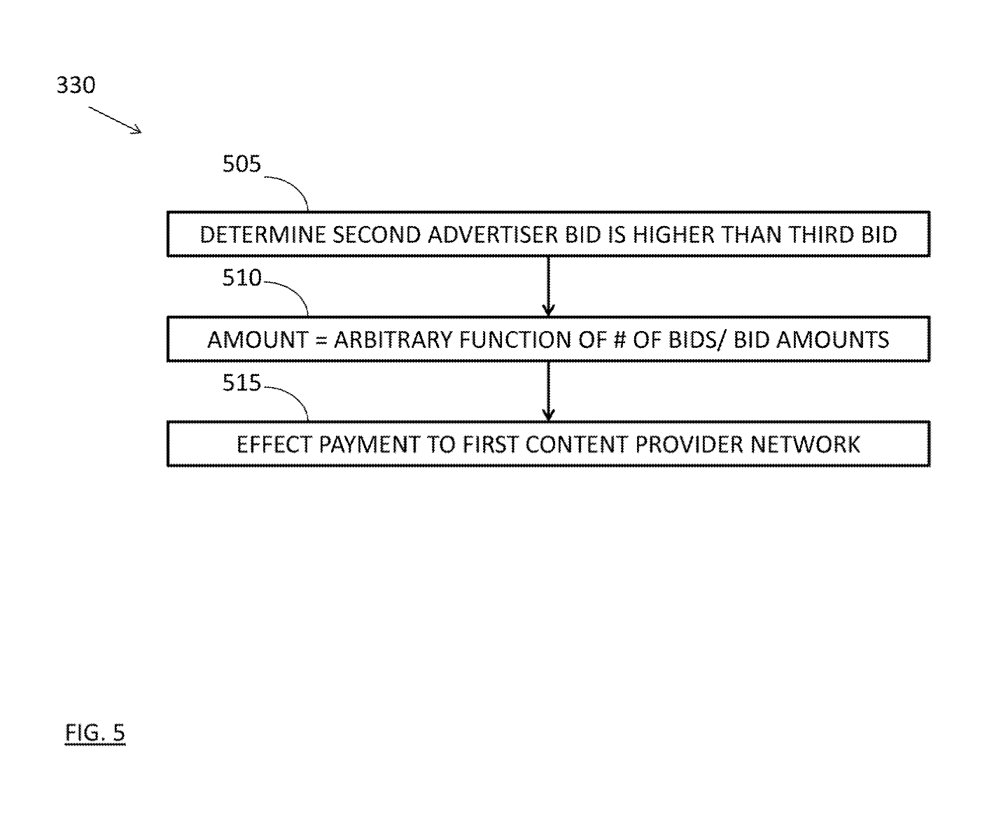

FIG. 5 is a flowchart illustrating example steps associated with an alternative implementation associated with calculating an amount to pay the first advertiser network for submitting the first and second bids (330). At step 505, a determination is made that the second bid, which was received from the first advertiser network, is higher than the third bid. At step 510, the amount to be paid to the first advertiser network is calculated to as a function of an arbitrary number of number of bids and the values of the bids submitted by the first advertiser network and the second advertiser network. Thereafter, payment, based on the calculation, is effected to the first advertiser network.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

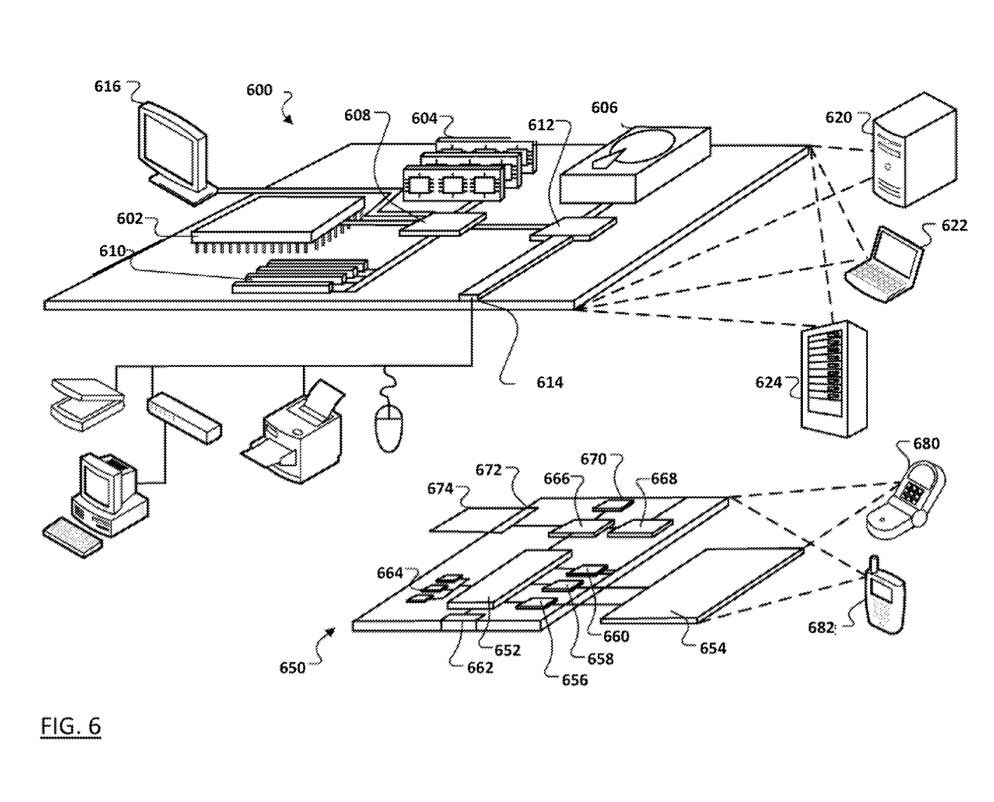

FIG. 6 shows an example of a computing device 600 and a mobile computing device that can be used to implement the techniques described in the present specification. The computing device 600 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the subject matter described and/or claimed in this document.

The computing device 600 includes a processor 602, a memory 604, a storage device 606, a high-speed interface 608 connecting to the memory 604 and multiple high-speed expansion ports 610, and a low-speed interface 612 connecting to a low-speed expansion port 614 and the storage device 606. Each of the processor 602, the memory 604, the storage device 606, the high-speed interface 608, the high-speed expansion ports 610, and the low-speed interface 612, are interconnected using various busses, and can be mounted on a common motherboard or in other manners as appropriate. The processor 602 can process instructions for execution within the computing device 600, including instructions stored in the memory 604 or on the storage device 606 to display graphical information for a GUI on an external input/output device, such as a display 616 coupled to the high-speed interface 608. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 604 stores information within the computing device 600. In some implementations, the memory 604 is a volatile memory unit or units. In some implementations, the memory 604 is a non-volatile memory unit or units. The memory 604 can also be another form of computer-readable medium, such as a magnetic or optical disk.

The storage device 606 is capable of providing mass storage for the computing device 600. In some implementations, the storage device 606 can be or contain a computer-readable medium, e.g., a computer-readable storage medium such as a floppy disk device, a hard disk device, an optical disk device, or a tape device, a flash memory or other similar solid state memory device, or an array of devices, including devices in a storage area network or other configurations. A computer program product can also be tangibly embodied in an information carrier. The computer program product can also contain instructions that, when executed, perform one or more methods, such as those described above. The computer program product can also be tangibly embodied in a computer- or machine-readable medium, such as the memory 604, the storage device 606, or memory on the processor 602.

The high-speed interface 608 manages bandwidth-intensive operations for the computing device 600, while the low-speed interface 612 manages lower bandwidth-intensive operations. Such allocation of functions is exemplary only. In some implementations, the high-speed interface 608 is coupled to the memory 604, the display 616 (e.g., through a graphics processor or accelerator), and to the high-speed expansion ports 610, which can accept various expansion cards (not shown). In the implementation, the low-speed interface 612 is coupled to the storage device 606 and the low-speed expansion port 614. The low-speed expansion port 614, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 600 can be implemented in a number of different forms, as shown in the figure. For example, it can be implemented as a standard server 620, or multiple times in a group of such servers. In addition, it can be implemented in a personal computer such as a laptop computer 622. It can also be implemented as part of a rack server system 624. Alternatively, components from the computing device 600 can be combined with other components in a mobile device (not shown), such as a mobile computing device 650. Each of such devices can contain one or more of the computing device 600 and the mobile computing device 650, and an entire system can be made up of multiple computing devices communicating with each other.

The mobile computing device 650 includes a processor 652, a memory 664, an input/output device such as a display 654, a communication interface 666, and a transceiver 668, among other components. The mobile computing device 650 can also be provided with a storage device, such as a micro-drive or other device, to provide additional storage. Each of the processor 652, the memory 664, the display 654, the communication interface 666, and the transceiver 668, are interconnected using various buses, and several of the components can be mounted on a common motherboard or in other manners as appropriate.

The processor 652 can execute instructions within the mobile computing device 650, including instructions stored in the memory 664. The processor 652 can be implemented as a chipset of chips that include separate and multiple analog and digital processors. The processor 652 can provide, for example, for coordination of the other components of the mobile computing device 650, such as control of user interfaces, applications run by the mobile computing device 650, and wireless communication by the mobile computing device 650.

The processor 652 can communicate with a user through a control interface 658 and a display interface 656 coupled to the display 654. The display 654 can be, for example, a TFT (Thin-Film-Transistor Liquid Crystal Display) display or an OLED (Organic Light Emitting Diode) display, or other appropriate display technology. The display interface 656 can comprise appropriate circuitry for driving the display 654 to present graphical and other information to a user. The control interface 658 can receive commands from a user and convert them for submission to the processor 652. In addition, an external interface 662 can provide communication with the processor 652, so as to enable near area communication of the mobile computing device 650 with other devices. The external interface 662 can provide, for example, for wired communication in some implementations, or for wireless communication in other implementations, and multiple interfaces can also be used.

The memory 664 stores information within the mobile computing device 650. The memory 664 can be implemented as one or more of a computer-readable medium or media, a volatile memory unit or units, or a non-volatile memory unit or units. An expansion memory 674 can also be provided and connected to the mobile computing device 650 through an expansion interface 672, which can include, for example, a SIMM (Single In Line Memory Module) card interface. The expansion memory 674 can provide extra storage space for the mobile computing device 650, or can also store applications or other information for the mobile computing device 650. Specifically, the expansion memory 674 can include instructions to carry out or supplement the processes described above, and can include secure information also. Thus, for example, the expansion memory 674 can be provided as a security module for the mobile computing device 650, and can be programmed with instructions that permit secure use of the mobile computing device 650. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 664, the expansion memory 674, or memory on the processor 652. In some implementations, the computer program product can be received in a propagated signal, for example, over the transceiver 668 or the external interface 662.

The mobile computing device 650 can communicate wirelessly through the communication interface 666, which can include digital signal processing circuitry where necessary. The communication interface 666 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 668 using a radio-frequency. In addition, short-range communication can occur, such as using a Bluetooth, Wi-Fi, or other such transceiver (not shown). In addition, a GPS (Global Positioning System) receiver module 670 can provide additional navigation- and location-related wireless data to the mobile computing device 650, which can be used as appropriate by applications running on the mobile computing device 650.

The mobile computing device 650 can also communicate audibly using an audio codec 660, which can receive spoken information from a user and convert it to usable digital information. The audio codec 660 can likewise generate audible sound for a user, such as through a speaker, e.g., in a handset of the mobile computing device 650. Such sound can include sound from voice telephone calls, can include recorded sound (e.g., voice messages, music files, etc.) and can also include sound generated by applications operating on the mobile computing device 650.

The mobile computing device 650 can be implemented in a number of different forms, as shown in the figure. For example, it can be implemented as a cellular telephone 680. It can also be implemented as part of a smart-phone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable storage medium and computer-readable storage medium refer to any computer program product, apparatus and/or device (e.g., magnetic discs, optical disks, memory, Programmable Logic Devices (PLDs)) used to provide machine instructions and/or data to a programmable processor, including a machine-readable storage medium that receives machine instructions as a machine-readable signal. The term machine-readable signal refers to any signal used to provide machine instructions and/or data to a programmable processor. A machine-readable storage medium does not include a machine-readable signal.

Also as used herein, the term “in response to” refers, generally, to sequence of one or more actions that occurs directly or in directly following a given event or occurrence.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A computer-implemented method for providing an incentive to a content provider network to submit multiple bids, the method comprising:
receiving, by one or more processors executing code, a first bid and a second bid from a same content provider network;
receiving, by the one or more processors, from a computing device associated with a second content provider network, a third bid;
determining, by the one or more processors, that the same content provider network submitted two highest bids based on values of the first bid, the second bid, and the third bid;
calculating, by the one or more processors, a first amount to charge the same content provider network that provided the two highest bids, wherein the first amount is less than an amount of the first bid; and
after calculating the first amount, calculating, by the one or more processors, a second amount to pay the same content provider network for providing both of the two highest, wherein the second amount is less than the first amount and the second amount is calculated based on a difference between the second bid and third bid.

2. The method of claim 1, further comprising: in response to the first calculating step, charging the first amount to a first content provider associated with the same content provider network.

3. The method of claim 2, further comprising: in response to the second calculating step, paying the second amount to the first content provider network, wherein payment to the first content provider network comprises an incentive.

4. The method of claim 1, wherein the second amount is calculated by alpha*(b_(m)−b_(n)), wherein:
alpha is a real number between, but not including, 0 and 1,
m and n are integers with m being greater than n, and
b is a bid having a ranking of m or n.

5. The method of claim 4, wherein m=2 and n=3 such that b_(2) is a second highest ranked bid and b_(3) is a third highest ranked bid.

6. The method of claim 1, wherein each of the first, second, and third bids are for placement of a creative on a page associated with a publisher, wherein the page comprises slots for two or more creatives.

7. The method of claim 1, wherein at least one processor is associated with a content provider network exchange.

8. (canceled)

9. The method of claim 1, wherein each of the first bid, the second bid and the third bid is for placement of a creative on a page associated with a publisher.

10. The method of claim 1, wherein the second amount is calculated using a function of a number of bids submitted and values of the bids submitted by the same content provider network and the second content provider network.

11. The method of claim 1, further comprising third calculating, with the one or more processors, a third amount to pay a publisher of content associated with the first bid.

12. The method of claim 1, wherein the third amount is calculated by (1-alpha)*b_(2)+alpha*b_(3).

13. The method of claim 9, wherein the third amount is calculated to equal an amount of the higher of the second and third bids minus a second amount payment received by the first content provider network.

14. A system for incentivizing at least one of a plurality of content provider networks for submitting a plurality of bids, the system including one or more processors configured to interact with a computer readable medium in order to perform operations comprising:
receiving, by one or more processors executing code, a first bid and a second bid from a same content provider network;
receiving, by the one or more processors, from a computing device associated with a second content provider network, a third bid;
determining, by the one or more processors, that the same content provider network submitted two highest bids based on values of the first bid, the second bid, and the third bid;
calculating, by the one or more processors, a first amount to charge the same content provider network that provided the two highest bids, wherein the first amount is less than an amount of the first bid; and
after calculating the first amount, calculating, by the one or more processors, a second amount to pay the same content provider network for providing both of the two highest, wherein the second amount is less than the first amount and the second amount is calculated based on a difference between the second bid and third bid.

15. The system of claim 14, wherein the second bid is higher than the third bid.

16. The system of claim 14, wherein the first amount equals the amount of the second bid.

17. The system of claim 14, wherein the second amount is calculated by alpha*(b_(2)−b_(3).

18. The system of claim 17, wherein alpha>0, b_(2) is the amount of the second bid and b_(3) denotes the third bid.

19. The system of claim 14, wherein the one or more processors is associated with a content provider network exchange.

20. The system of claim 14, wherein each of the first bid, the second bid and the third bid is for placement of a creative on a page associated with a publisher.

21. The system of claim 14, wherein the second amount is calculated using a function of a number of bids submitted and values of the bids submitted by the same content provider network and the second content provider network.

22. The system of claim 14, wherein the one or more processors are configured to interact with a computer readable medium in order to perform operations comprising calculating, with the one or more processors, a third amount to pay a publisher of content associated with the first bid.

23. The system of claim 22, wherein the third amount is calculated by (1-alpha)*b_(2)+alpha*b_(3).

24. The system of claim 22, wherein the third amount is calculated to equal an amount of which is higher of the second and third bids minus a second amount payment received by the content provider network.

25. A computer storage medium encoded with a computer program, the program comprising instructions that when executed by one or more data processing apparatus cause the one or more data processing apparatus to perform operations comprising:
receiving, by one or more processors executing code, a first bid and a second bid from a same content provider network;
receiving, by the one or more processors, from a computing device associated with a second content provider network, a third bid;
determining, by the one or more processors, that the same content provider network submitted two highest bids based on values of the first bid, the second bid, and the third bid;
calculating, by the one or more processors, a first amount to charge the same content provider network that provided the two highest bids, wherein the first amount is less than an amount of the first bid; and
after calculating the first amount, calculating, by the one or more processors, a second amount to pay the same content provider network for providing both of the two highest, wherein the second amount is less than the first amount and the second amount is calculated based on a difference between the second bid and third bid.

26. A computer-implemented method for providing an incentive to a content provider network to submit multiple bids, the method comprising:
processing, with at least one processor executing code, a plurality of bids respectively received from a plurality of content provider networks to define a ranking of submitted bids;
determining, with the at least one processor and in accordance with the ranking, that at least two highest bids have been received from a first content provider network among the plurality of content provider networks;
computing, with the at least one processor, an incentive for the first content provider network in accordance with:
a) a first compensation formula for providing the at least two of the highest bids, or
b) a second compensation formula;
wherein incentive associated with the first compensation formula is higher than incentive associated with the second compensation formula; and
providing a result of the computing step over a network to the particular content provider network.

27. The method of claim 26, wherein the computing step further comprises applying alpha*(b_(m)−b_(n)) as the first compensation formula,
wherein alpha is a real number between, but not including, 0 and 1,
m and n are integers with m being greater than n, and
b is a bid having a ranking of m or n.

28. The method of claim 27, wherein m=2 and n=3 such that b_(2) is a second highest ranked bid and b_(3) is a third highest ranked bid.

29. The method of claim 26, wherein each of the bids is for placement of a creative on a page associated with a publisher, wherein the page comprises slots for two or more creatives.

30. The method of claim 26, wherein the at least one processor is associated with a content provider network exchange.
